(19) United States
(12) Patent Application Publication
(10) Pub. No.: US 2013/0083527 A1
(43) Pub. Date: Apr. 4, 2013

(54) LAMP WITH DETACHABLE LIGHT SOURCE SUPPORTER

(71) Applicant: KUO-CHENG CHANG, Chu-Nan (TW)

(72) Inventor: KUO-CHENG CHANG, Chu-Nan (TW)

(73) Assignee: FOXSEMICON INTEGRATED TECHNOLOGY, INC., Chu-Nan (TW)

(21) Appl. No.: 13/330,705

(22) Filed: Dec. 20, 2011

(30) Foreign Application Priority Data
Sep. 29, 2011 (TW) 100135150

(51) Int. Cl. F21V 21/00

(52) U.S. Cl. 362/249.01

(57) ABSTRACT

A lamp includes a lamp holder, a supporting board and a plurality of light sources. The lamp holder has a holding surface for holding the supporting board. The supporting board has a fixing portion, a first supporting portion and a second supporting portion. The fixing portion is fixed on the holding surface. The first and second supporting portions are adjacent to each other. The first supporting portion has a first supporting surface. The second supporting portion has a second supporting surface oblique to the first supporting surface. The plurality of light sources is arranged respectively on the first and second supporting surfaces.

### BACKGROUND

1. Technical Field

The present disclosure generally relates to lamps, and particular to a lamp with detachable light source supporter.

2. Description of Related Art

With the continuing development of scientific technology, lamps have been widely used for interior and exterior illumination. In the design of a lamp, light field is always one of major concerns. Most lamps generally include light sources arranged on lamp holders in a certain manner to generate predetermined shape of light fields. However, these types of light field are not always suitable for a particular application. When adjusting a light field of a lamp, a new lamp holder with distinct configurations relative to the current ones must be employed. However, the manufacture of the new lamp holder is always impractical and costly, and the replacement of lamp holders is relatively inconvenient.

Therefore, it is necessary to provide a lamp to overcome above shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

FIG. 1 is a schematic view of a lamp in accordance with a first embodiment of the present disclosure.

FIG. 2 is an isometric view of a supporting board of the lamp of FIG. 1.

FIG. 3 is a schematic view of a lamp in accordance with a second embodiment of the present disclosure.

FIG. 4 is a schematic view of a lamp in accordance with a third embodiment of the present disclosure.

FIG. 5 is a schematic view of a lamp in accordance with a fourth embodiment of the present disclosure.

FIG. 6 is a schematic view of a lamp in accordance with a fifth embodiment of the present disclosure.

FIG. 7 is a schematic view of a lamp in accordance with a sixth embodiment of the present disclosure.

### DETAILED DESCRIPTION

Reference will now be made to the drawings to describe the present lamps, in detail.

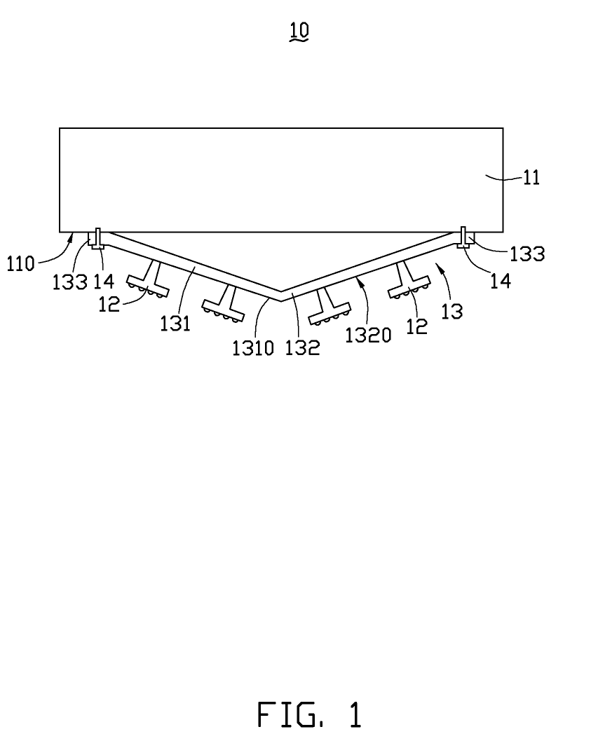

Referring to FIG. 1, a lamp 10 according to a first exemplary embodiment of the present disclosure includes a lamp holder 11, a plurality of light sources 12 and a supporting board 13.

The lamp holder 11 includes a holding surface 110 for supporting the supporting board 13. In this embodiment, the holding surface 110 is planar.

The plurality of light sources 12 can be light emitting diodes (LEDs), traditional fluorescent tubes, discharge tube and so on. In this embodiment, the light sources 12 are LEDs.

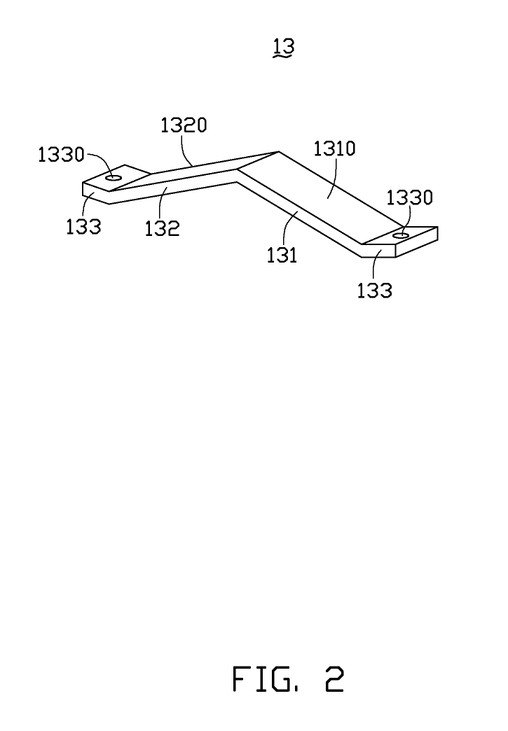

The supporting board 13 is for supporting the plurality of light sources 12. Referring to FIG. 2, the supporting board 13 is generally a long strip plate, and has a V-shaped profile. The supporting board 13 includes a first supporting portion 131, a second supporting portion 132 adjacent to the first supporting portion 131, and two fixing portions 133 respectively at lateral distal ends of first and second supporting portions 131, 132. In other words, the two fixing portions 133 have the first supporting portion 131 and the second supporting portions 132 located therebetween.

The first supporting portion 131 and the second supporting portions 132 are both for supporting the light sources 12. The first supporting portion 131 includes a supporting surface 1310. The second supporting portion 132 includes a supporting surface 1320. The supporting surfaces 1310, 1320 are both planar and cooperatively define an included angle a therebetween. The included angle a can range from 0˜180 degrees both inclusive. In this embodiment, the supporting surfaces 1310, 1320 are oblique to each other, and therefore the light sources 12 on the supporting surface 1310 have a light projecting direction different from that of the light sources 12 on the supporting surface 1320, thereby achieving predetermined light field.

The fixing portions 133 are attached and fixed to the holding surface 110 of the lamp holder 11. As such, the whole supporting board 13 is fixed to the lamp holder 11 via an engagement between the fixing portion 133 and the holding surface 110. In this embodiment, the fixing portion 133 has a through hole 1330 defined therethrough. As such, the fixing portion 133 can be detachably engaged with the lamp holder 11 by a fixing member 14 penetrating through the through hole 1330 with an end embedded into the lamp holder 11. In this embodiment, the fixing member 14 can be a bolt or a rivet.

The supporting board 13 is detachably fixed to the lamp holder 11 by the fixing member 14, so that different light field can be achieved by replacing the current supporting board 13 with a new one which has a different included angle between two adjacent supporting surfaces thereof. Due to that the supporting board 13 is just a strip plate and can be made by simple process, such as stamping, with relatively low cost, when adjusting light field, it is cost-efficient and convenient to replace the supporting board 13 instead of the traditional lamp holders 11 of the lamp 10.

It is to be said that, the number of the fixing portions 133 and the supporting portions 131, 132 can also be adjusted properly to meet different actual requirements.

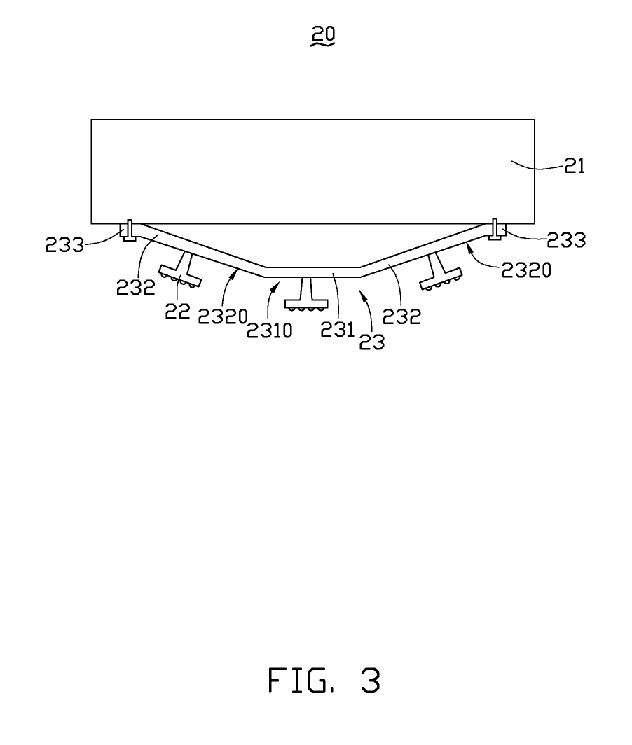

Referring to FIG. 3, a lamp 20 according to a second exemplary embodiment of the present disclosure is provided. The lamp 20 has a configuration generally similar to the lamp 10. The lamp 20 also includes a lamp holder 21, a plurality of light sources 22 and a supporting board 23. What is different from the lamp 10 is that, the supporting board 23 of the lamp 20 includes a first supporting portion 231, two second supporting portions 232 sandwiching the first supporting portion 231, and two fixing portions 233 at lateral distal ends of the two second supporting portions 232. The first supporting portion 231 includes a supporting surface 2310. The two second supporting portions 232 each have a supporting surface 2320. The supporting surface 2310 and the two supporting surfaces 2320 each sit in a plane oblique to the others, i.e., the supporting surface 2310 faces a direction different from facing directions of the two supporting surfaces 2320. As such, the light sources 22 arranged on the supporting surfaces 2310, 2320 project light towards three different directions. Accordingly, the light filed of the lamp 20 is more diversified.

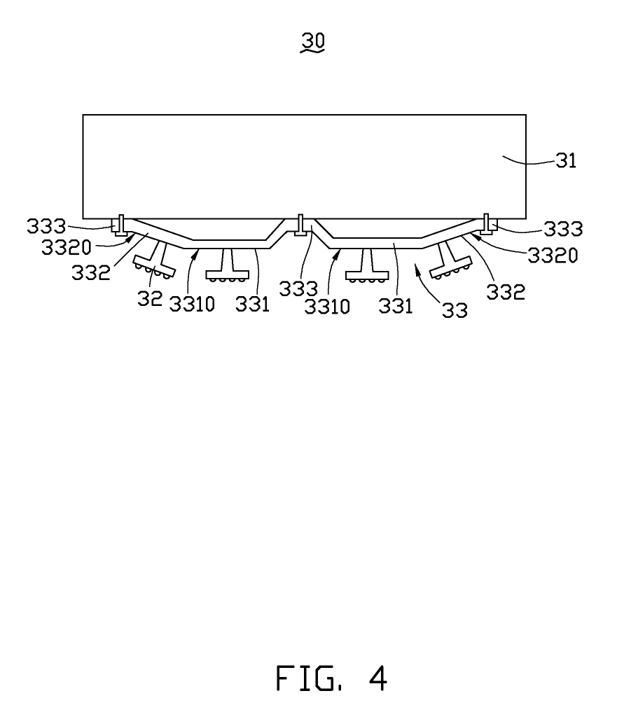

Referring to FIG. 4, a lamp 30 according to a third exemplary embodiment of the present disclosure is provided. The lamp 30 has a configuration generally similar to the lamp 20. The lamp 30 also includes a lamp holder 31, a plurality of light sources 32 and a supporting board 33. What is different from the lamp 20 is that, the supporting board 33 of the lamp 30 includes two first supporting portions 331 sandwiching a fixing portion 333, two second supporting portions 332 at lateral distal ends of the first supporting portions 331, and another two fixing portions 333 at lateral distal ends of the two second supporting portions 332. The two first supporting portions 331 each include a supporting surface 3310 parallel to each other. The two second supporting portions 332 each has a supporting surface 3320 oblique to each other. The supporting surface 3310 are oblique to any of the two supporting surface 3320. The fixing portion 333 sandwiched between the two first supporting portions 332 enhance an engagement of the lamp holder 31 and the supporting board 33.

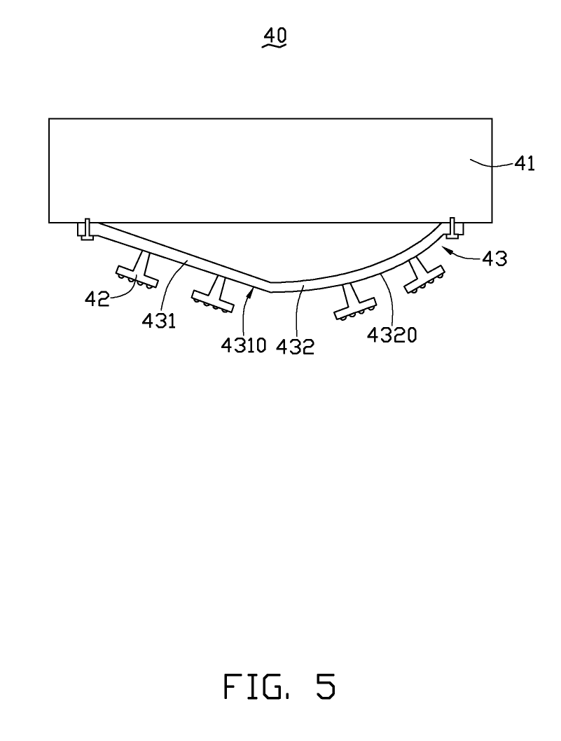

Referring to FIG. 5, a lamp 40 according to a fourth exemplary embodiment of the present disclosure is provided. The lamp 40 has a configuration generally similar to the lamp 10. The lamp 40 also includes a lamp holder 41, a plurality of light sources 42 and a supporting board 43. What is different from the lamp 10 is that, a first supporting portion 431 of the supporting board 43 includes a planar supporting surface 4310, and a second supporting portion 432 of the supporting board 43 includes a curved supporting surface 4320. In this embodiment, the second supporting portion 432 convex away from the lamp holder 41 to form the curved supporting surface 4320. It is to be said that, the second supporting portion 432 can also convex towards the lamp holder 41 to form a curved supporting surface.

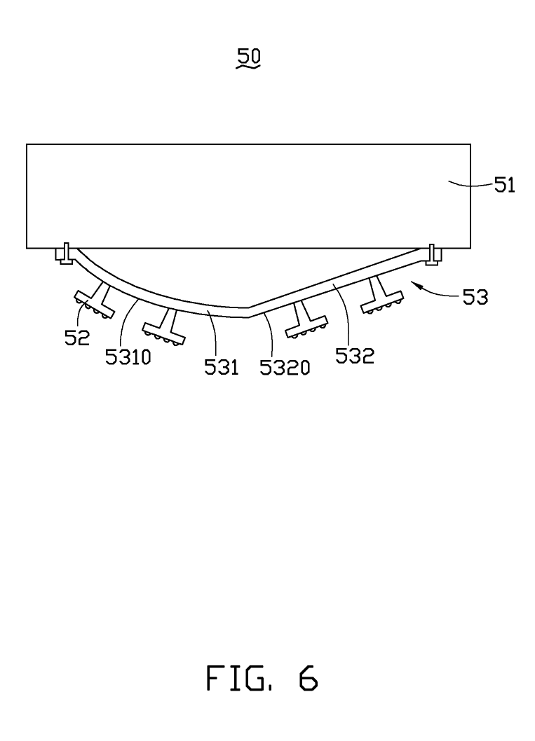

Referring to FIG. 6, a lamp 50 according to a fifth exemplary embodiment of the present disclosure is provided. The lamp 50 has a configuration generally similar to the lamp 10. The lamp 50 also includes a lamp holder 51, a plurality of light sources 52 and a supporting board 53. What is different from the lamp 10 is that, a first supporting portion 531 of the supporting board 53 includes a curved supporting surface 5310, and a second supporting portion 532 of the supporting board 53 includes a planar supporting surface 5320. In this embodiment, the first supporting portion 531 convex away from the lamp holder 51 to form the curved supporting surface 5310. It is to be said that, the first supporting portion 531 can also convex towards the lamp holder 51 to form a curved supporting surface.

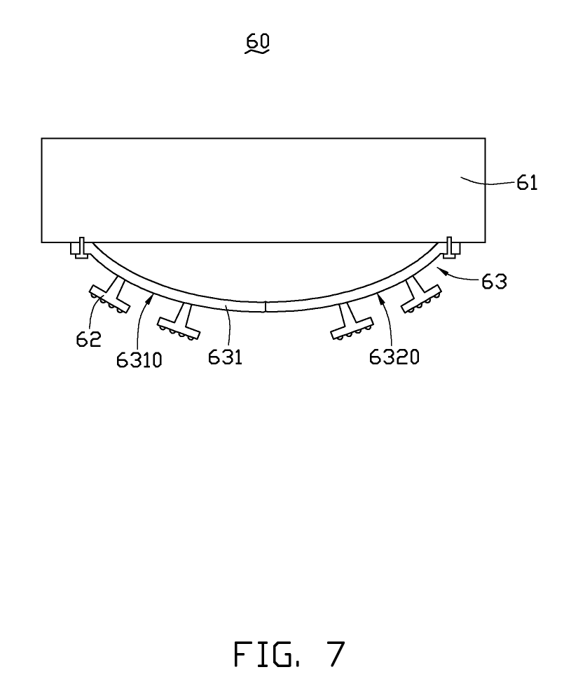

Referring to FIG. 7, a lamp 60 according to a sixth exemplary embodiment of the present disclosure is provided. The lamp 60 has a configuration generally similar to the lamp 10. The lamp 60 also includes a lamp holder 61, a plurality of light sources 62 and a supporting board 63. What is different from the lamp 10 is that, a first supporting portion 631 of the supporting board 63 includes a curved supporting surface 6310, and a second supporting portion 632 of the supporting board 63 also includes a curved supporting surface 6320. In this embodiment, the first supporting portion 631 convex away from the lamp holder 61 to form the curved supporting surface 6310, and the second supporting portion 632 also convex from the lamp holder 61 to form the curved supporting surface 6320. It is to be said that, anyone of the first supporting portion 631 and the second supporting portion 632 can convex towards the lamp holder 61 to form a curved supporting surface.

In this embodiment, the supporting surface 6310 has a curvature as same as the supporting surface 6320. It is to be said that, the curvature of the supporting surface 6310 can also different from that of the supporting surface 6320.

In addition, the different features of above embodiments can also be combined freely to achieve an undescribed configuration of the lamp.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A lamp comprising:
a lamp holder with a holding surface;
a supporting board comprising a fixing portion, a first supporting portion and a second supporting portion, the fixing portion being at a distal end of the first supporting portion or the second supporting portion, the fixing portion being fixed on the holding surface, the first and second supporting portions being connected, the first supporting portion having a first supporting surface, the second supporting portion having a second supporting surface oblique to the first supporting surface; and
a plurality of light sources arranged respectively on the first and second supporting surfaces.

2. The lamp according claim 1, wherein the holding surface of the lamp holder is planar.

3. The lamp according claim 1, wherein the fixing portion defines a through hole, the fixing portion being fixed on the holding surface by a fixing member penetrating through the through hole with an end engaged into the lamp holder.

4. The lamp according claim 1, wherein the first and second supporting surfaces are both planar.

5. The lamp according claim 4, wherein the first and second supporting surfaces connect each other.

6. The lamp according claim 1, wherein the first supporting surface is planar, and the second supporting surface is curved.

7. The lamp according claim 1, wherein the first and second supporting surfaces each are curved, the first supporting surface having a curvature as same as that of the second supporting surface.

8. The lamp according claim 1, wherein the first and second supporting surfaces are connected by an additional supporting surface located between the first and second supporting surfaces, the additional supporting surface facing a direction different from facing directions of the first and second supporting surfaces.

9. The lamp according claim 8, wherein the additional supporting surface has an additional light source mounted thereon.

10. The lamp according claim 1, wherein the first sand second supporting surfaces are connected to each other directly.

11. A lamp comprising:
a lamp holder with a holding surface;
a supporting board with a fixing portion, a first supporting portion and two second supporting portions, the fixing portion being at a distal end of the second supporting portion, the fixing portion being fixed on the holding surface, the first supporting portion being located between by the two second supporting portions, the first supporting portion having a first supporting surface, the two second supporting portion each having a second supporting surface oblique to each other, the first supporting surface being oblique to the second supporting surfaces; and
a plurality of light sources arranged respectively on the first and second supporting surfaces.

12. A lamp comprising:
a lamp holder with a holding surface;
a supporting board with a fixing portion, two first supporting portions and two second supporting portions, the fixing portion being sandwiched between the two first supporting portions, the fixing portion being fixed on the holding surface, the two first supporting portions being sandwiched by the two second supporting portions, the two first supporting portions each having a first supporting surface parallel to each other, the two second supporting portions each having a second supporting surface oblique to each other, the first supporting surfaces are oblique to the second supporting surfaces; and
a plurality of light sources arranged respectively on the first and second supporting surfaces.
